(19) United States
(12) Patent Application Publication
(10) Pub. No.: US 2022/0013761 A1
(43) Pub. Date: Jan. 13, 2022

(54) NONAQUEOUS ELECTROLYTE SECONDARY BATTERY POSITIVE ELECTRODE AND NONAQUEOUS ELECTROLYTE SECONDARY BATTERY

(71) Applicant: Panasonic Corporation, Kadoma-shi, Osaka (JP)

(72) Inventors: Harunari Shimamura, Hyogo (JP); Keisuke Ohara, Hyogo (JP); Yusuke Fukumoto, Osaka (JP)

(73) Assignee: Panasonic Corporation, Kadoma-shi, Osaka (JP)

(21) Appl. No.: 17/283,316

(22) PCT Filed: Sep. 27, 2019
(86) PCT No.: PCT/JP2019/038135

§ 371 Date: Apr. 7, 2021

(30) Foreign Application Priority Data
Oct. 25, 2018 (JP) 2018-200746

(51) Int. Cl. H01M 4/13; H01M 4/66; H01M 10/0525; H01M 4/62

(52) U.S. Cl. CPC H01M 4/13; H01M 4/661; H01M 2004/028; H01M 4/621; H01M 10/0525

(57) ABSTRACT

This nonaqueous electrolyte secondary battery positive electrode comprises a positive electrode collector which is mainly composed of Ti, and a positive electrode active material layer which is disposed on the positive electrode collector, wherein the positive electrode active material layer includes a positive electrode active material and a binder and has a density of 3 g/cc or more, the positive electrode active material has an average particle size in a range of 2 to 20 μm, the positive electrode collector has a thickness in a range of 1 to 8 μm, and the content of the binder in the positive electrode active material layer satisfies the formula, y=0.006x2+0.0262x+a (y is the content (mass %) of the binder, x is the thickness of the positive electrode collector, and a is a real number from 0.3 to 2.2).

### TECHNICAL FIELD

The present disclosure relates to techniques of a positive electrode for a non-aqueous electrolyte secondary battery, and a non-aqueous electrolyte secondary battery.

### BACKGROUND ART

Recently, there has been widely used a non-aqueous electrolyte secondary battery which comprises a positive electrode, a negative electrode, and a non-aqueous electrolyte and which achieves charge and discharge by movement of lithium ions or the like between the positive electrode and the negative electrode, as a secondary battery providing high output and a high energy density.

While a positive electrode for use in a non-aqueous electrolyte secondary battery generally comprises a positive electrode current collector including Al foil, and a positive electrode active material layer provided on the positive electrode current collector, there has been recently proposed use of Ti foil as a positive electrode current collector for the purposes of an increase in capacity of a battery and an enhancement in corrosion resistance of a positive electrode current collector (see, for example, Patent Literatures 1 and 2).

### CITATION LIST

### Patent Literature

PATENT LITERATURE 1: Japanese Unexamined Patent Application Publication No. 2001-085016
PATENT LITERATURE 2: Japanese Unexamined Patent Application Publication No. 2011-091019

### SUMMARY

When a positive electrode current collector containing Ti as a main component, such as Ti foil, is used, a binding force between the positive electrode current collector and a positive electrode active material layer cannot be sufficiently ensured, and the positive electrode active material layer may be partially peeled from the positive electrode current collector upon production of a positive electrode, upon production and/or use of a battery, and/or the like. This may result in remarkable deterioration in charge and discharge cycle characteristics of a battery and/or a remarkable temperature rise of a battery upon internal short.

It is an advantage of the present disclosure to provide a positive electrode for a non-aqueous electrolyte secondary battery, and a non-aqueous electrolyte secondary battery, in which deterioration in charge and discharge cycle characteristics of the battery and the temperature rise of the battery upon internal short may be suppressed when a positive electrode current collector containing Ti as a main component is used.

A positive electrode for a non-aqueous electrolyte secondary battery of one aspect of the present disclosure comprises a positive electrode current collector containing Ti as a main component, and a positive electrode active material layer disposed on the positive electrode current collector, wherein the positive electrode active material layer includes a positive electrode active material and a binder, and has a density of 3 g/cc or more, the positive electrode active material has an average particle size in the range of 2 μm to 20 μm, the positive electrode current collector has a thickness in the range of 1 μm to 8 μm, and a content of the binder in the positive electrode active material layer satisfies the following expression:

y=0.006x²+0.0262x+a

wherein y is the binder content (mass %), x is the thickness of the positive electrode current collector, and a is a real number of 0.3 to 2.2.

A non-aqueous electrolyte secondary battery of one aspect of the present disclosure comprises a positive electrode, a negative electrode, and a non-aqueous electrolyte, wherein the positive electrode is the positive electrode for a non-aqueous electrolyte secondary battery.

According to one aspect of the present disclosure, deterioration in charge and discharge cycle characteristics of a battery and the temperature rise of a battery upon internal short may be suppressed.

### BRIEF DESCRIPTION OF DRAWING

FIG. 1 is a sectional view of a non-aqueous electrolyte secondary battery of an exemplary embodiment.

FIG. 2 is a diagram representing the range of the binder content relative to the thickness of a positive electrode current collector in the present embodiment.

### DESCRIPTION OF EMBODIMENTS

A positive electrode for a non-aqueous electrolyte secondary battery of one aspect of the present disclosure comprises a positive electrode current collector containing Ti as a main component, and a positive electrode active material layer disposed on the positive electrode current collector, wherein the positive electrode active material layer includes a positive electrode active material and a binder, and has a density of 3 g/cc or more, the positive electrode active material has an average particle size in the range of 2 μm to 20 μm, the positive electrode current collector has a thickness in the range of 1 μm to 8 μm, and the content of the binder in the positive electrode active material layer satisfies the following expression:

y=0.006x²+0.0262x+a

wherein y is the binder content (mass %), x is the thickness of the positive electrode current collector, and a is a real number of 0.3 to 2.2.

A positive electrode is usually required to be rolled so as to allow a positive electrode active material layer to have a high density of 3 g/cc or more. If a positive electrode is rolled, not only a positive electrode active material layer, but also a positive electrode current collector is elongated and thus a large difference in rate of elongation between both causes any stress to be applied on such a positive electrode active material layer located on such a positive electrode current collector. In particular, a positive electrode current collector containing Ti as a main component, such as Ti foil, is low in rate of elongation upon rolling of such a positive electrode, as compared with conventional Al foil, and thus such a positive electrode current collector cannot address the elongation of such a positive electrode active material layer, and a large stress is applied to such a positive electrode active material layer. As a result, a binding force between such a positive electrode active material layer and such a positive electrode current collector may be decreased, thereby causing such a positive electrode active material layer to be partially peeled from such a positive electrode current collector upon production of a positive electrode, upon production and/or use of a battery, and/or the like. However, the positive electrode for a non-aqueous electrolyte secondary battery of one aspect of the present disclosure, in which the thickness of the positive electrode current collector containing Ti as a main component is prescribed within the above predetermined range and the average particle size of the positive electrode active material and the binder content are prescribed within the above respective predetermined ranges, thus, for example, allows for a decrease in difference between the rate of elongation of the positive electrode active material layer and the rate of elongation of the positive electrode current collector upon rolling of the positive electrode, and allows a binding force between the positive electrode active material layer and the positive electrode current collector to be sufficiently ensured. As a result, peeling of the positive electrode active material layer is suppressed upon production of the positive electrode and/or upon production and/or use of a battery, and thus deterioration in charge and discharge cycle characteristics of a battery and the temperature rise of a battery upon internal short are suppressed.

Hereinafter, an exemplary embodiment will be described in detail. The drawings referred to in the description of embodiments are schematically illustrated, and the dimensional ratio of any constituent component depicted in the drawings may be different from that of any actual constituent component.

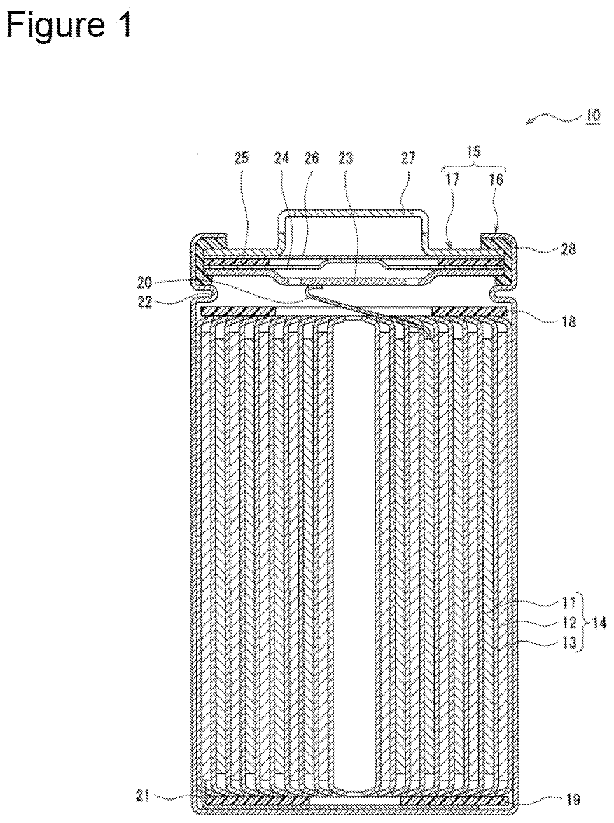

FIG. 1 is a sectional view of a non-aqueous electrolyte secondary battery of an exemplary embodiment. A non-aqueous electrolyte secondary battery 10 shown in FIG. 1 comprises a wound-type electrode assembly 14 formed by winding a positive electrode 11 and a negative electrode 12 with a separator 13 being interposed therebetween, a non-aqueous electrolyte, insulating plates 18 and 19 respectively disposed on and under the electrode assembly 14, and a battery case 15 that houses such members. The battery case 15 is configured by a cylindrical case body 16 having a closed-end, and a sealing assembly 17 for closing the opening of the case body 16. Another form of electrode assembly, for example, a flat-type electrode assembly or a stacked electrode assembly formed by stacking alternately a positive electrode and a negative electrode with a separator being interposed therebetween may be here applied instead of the wound-type electrode assembly 14. Examples of the battery case 15 can include a cylindrical, rectangular, coin-shaped, or button-shaped metal outer can, and a pouch outer body formed by laminating a resin sheet and a metal sheet.

The case body 16 is, for example, a cylindrical metal outer can having a closed-end. A gasket 28 is disposed between the case body 16 and the sealing assembly 17 to ensure that the interior of the battery is tightly sealed. The case body 16 includes, for example, a projecting portion 22 which has a lateral surface partially projected inward and which supports the sealing assembly 17. The projecting portion 22 is preferably formed annularly along the circumferential direction of the case body 16, and the upper surface thereof supports the sealing assembly 17.

The sealing assembly 17 has a structure in which a filter 23, a lower vent member 24, an insulating member 25, an upper vent member 26, and a cap 27 are stacked in the listed order sequentially from the electrode assembly 14 side. Each of the members constituting the sealing assembly 17 has, for example, a disk or ring shape, and the members other than the insulating member 25 are electrically connected to each other. The lower vent member 24 and the upper vent member 26 are connected to each other at respective middle portions and the insulating member 25 is interposed between respective circumferences. If the internal pressure in the non-aqueous electrolyte secondary battery 10 increases by heat generation due to, for example, internal short, the lower vent member 24 changes its shape so as to, for example, push up the upper vent member 26 toward the cap 27, and thus ruptures, thereby breaking the electrical connection between the lower vent member 24 and the upper vent member 26. If the internal pressure further increases, the upper vent member 26 ruptures to discharge gas through the opening of the cap 27.

In the non-aqueous electrolyte secondary battery 10 shown in FIG. 1, a positive electrode lead 20 attached to the positive electrode 11 passes through a though-hole in the insulating plate 18 and extends toward the sealing assembly 17, and a negative electrode lead 21 attached to the negative electrode 12 passes on the outside of the insulating plate 19 and extends toward the bottom of the case body 16. The positive electrode lead 20 is connected to the lower surface of the filter 23, which is the bottom board of the sealing assembly 17, by welding or the like, and the cap 27, which is the top board of the sealing assembly 17 and electrically connected to the filter 23, serves as a positive electrode terminal. The negative electrode lead 21 is connected to the inner surface of the bottom of the case body 16 by welding or the like, and the case body 16 serves as a negative electrode terminal.

Hereinafter, each constituent component of the non-aqueous electrolyte secondary battery 10 will be described in detail.

[Positive Electrode]

The positive electrode 11 comprises, for example, a positive electrode current collector containing Ti as a main component, and a positive electrode active material layer formed on the positive electrode current collector. The positive electrode active material layer includes a positive electrode active material and a binder. The positive electrode active material layer suitably includes a conductive agent. The positive electrode 11 can be produced by, for example, coating the positive electrode current collector with a positive electrode mixture slurry including a positive electrode active material, a binder, a conductive agent, and the like, drying the resultant to form the positive electrode active material layer, and thereafter rolling the positive electrode 11 by a roller or the like in order to increase the density of the positive electrode active material layer.

The positive electrode current collector containing Ti as a main component means a positive electrode current collector in which the content of Ti in the positive electrode current collector is 99% or more. The positive electrode current collector containing Ti as a main component may include an element other than Ti, examples include Fe, Si, N, C, O, and H, and the content of such each element is preferably as follows: Fe: 0.01% to 0.2%, Si: 0.011 to 0.02%, N: 0.001% to 0.02%, C: 0.001% to 0.02%, O: 0.04% to 0.14%, and H: 0.003% to 0.01%.

The positive electrode current collector containing Ti as a main component has a thickness in the range of 1 μm to 8 μm, preferably, in the range of 3 μm to 6 μm. In a case where the thickness of the positive electrode current collector containing Ti as a main component is in the range, for example, the rate of elongation of the positive electrode current collector upon rolling of the positive electrode 11 can be enhanced and can be decreased in difference from the rate of elongation of the positive electrode active material layer, and a binding force between the positive electrode active material layer and the positive electrode current collector can be sufficiently ensured, as compared with a case where the thickness is more than 8 μm. Accordingly, peeling of the positive electrode active material layer is suppressed, and then deterioration in charge and discharge cycle characteristics and the temperature rise of a battery upon internal short are suppressed. In a case where the thickness of the positive electrode current collector containing Ti as a main component is less than 1 μm, mechanical strength is low, and the positive electrode 11 and the electrode assembly 14 are difficult to produce. In a case where the positive electrode current collector containing Ti as a main component has the same thickness as that of conventional Al foil, the positive electrode current collector is rapidly fused on the occurrence of internal short between the positive electrode current collector and the negative electrode and allows for an enhancement in safety of a battery, as compared with such conventional Al foil.

The positive electrode active material layer has a density of 3 g/cm³ or more, preferably 3.5 g/cm³ or more. In a case where the density of the positive electrode active material layer is 3 g/cm³ or more, a battery can be increased in energy density. It is necessary to roll the positive electrode 11, as described above, in order that the density of the positive electrode active material layer is 3 g/cm³ or more. In the present embodiment, the difference between the rate of elongation of the positive electrode active material layer and the rate of elongation of the positive electrode current collector, upon rolling of the positive electrode 11, is small, and thus a binding force between the positive electrode active material layer and the positive electrode current collector is sufficiently ensured, even if the positive electrode 11 is rolled in order that the density of the positive electrode active material layer is 3 g/cm³ or more.

The thickness of the positive electrode active material layer is preferably, for example, in the range of 100 μm to 250 μm, more preferably in the range of 120 μm to 200 μm from the viewpoint of a binding force between the positive electrode active material layer and the positive electrode current collector and from the viewpoint of an increase in capacity of a battery.

Examples of the positive electrode active material include a lithium/transition metal complex oxide, and examples include lithium cobaltite, lithium manganate, lithium nickelate, lithium nickel manganese complex oxide, and lithium nickel cobalt complex oxide. The positive electrode active material preferably includes, for example, one which is a complex oxide including Ni and Li and which is a complex oxide where the content of Ni in the complex oxide is in the range of 70 mol % to 100 mol % based on the total molar number of any constituent element other than Li and oxygen in the complex oxide, from the viewpoint of an increase in capacity of a secondary battery. More specifically, the positive electrode active material is represented by general formula LiNiₓCo_{y}Al_{z}O₂, and is configured so that x+y+z=100 is satisfied within the respective ranges: x=70 to 98%, y=1 to 15%, and z=1 to 15%. Alternatively, the positive electrode active material is represented by general formula LiNiₓCo_{y}Mn_{z}O₂, and is configured so that x+y+z=100 is satisfied within the respective ranges: x=70 to 98%, y=1 to 15%, and z=1 to 15%. The positive electrode active material also includes a case where Ni, Co, and Mn are partially replaced with Al, Ti, P, B, Si, Nb, C, or the like, and a case where a particle surface of the positive electrode active material is covered with a compound including Al, Ti, P, B, Si, Nb, C, or the like. The amount of replacement and the amount of addition are each about 0.1% to 7% in total.

The positive electrode active material has an average particle size in the range of 2 μm to 20 μm, preferably, in the range of 3 μm to 15 μm. In a case where the average particle size of the positive electrode active material is in the range, for example, the rate of elongation of the positive electrode active material layer upon rolling of the positive electrode 11 can be close to the rate of elongation of the positive electrode current collector and a binding force between the positive electrode active material layer and the positive electrode current collector can be sufficiently ensured, as compared with a case where the average particle size is out of the range. Accordingly, peeling of the positive electrode active material layer is suppressed, and then deterioration in charge and discharge cycle characteristics and the temperature rise of a battery upon internal short are suppressed. The average particle size here means any average particle size which is a volume average particle size measured by a laser diffraction method and which is a median size at a volume accumulated value of 50% in a particle size distribution. The average particle size can be measured using, for example, a laser diffraction particle size distribution measuring apparatus (Microtrac HRA manufactured by Nikkiso Co., Ltd.).

The positive electrode active material preferably has, for example, a specific surface area in the range of 0.15 to 2 m²/g from the viewpoint that, for example, the rate of elongation of the positive electrode active material layer upon rolling of the positive electrode 11 can be close to the rate of elongation of the positive electrode current collector and a binding force between the positive electrode active material layer and the positive electrode current collector can be sufficiently ensured. The specific surface area is measured according to a gas adsorption method.

Examples of the binder include fluoro resins such as polytetrafluoroethylene (PTFE) and poly(vinylidene fluoride) (PVDF), polyacrylonitrile (PAN), polyimides, acrylic resins, and polyolefins. These may be used singly or may be used in combinations of two or more thereof.

The content of the binder in the positive electrode active material satisfies the following expression.

y=0.006x²+0.0262x+a

y is the binder content (mass %). x is the thickness (1 to 8 μm) of the positive electrode current collector. a is a real number of 0.3 to 2.2, preferably a real number of 0.69 to 1.8.

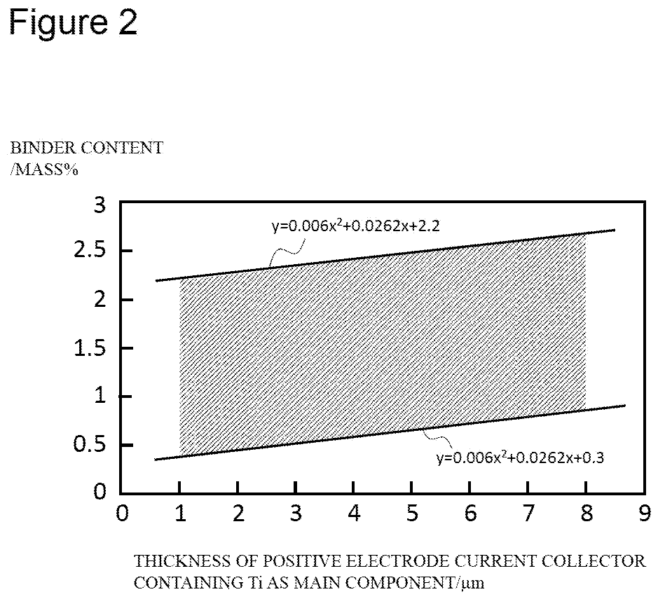

FIG. 2 is a diagram representing the range of the binder content relative to the thickness of the positive electrode current collector in the present embodiment. A hatching region represented in FIG. 2 corresponds to the content of the binder in the positive electrode active material relative to the thickness of the positive electrode current collector in the present embodiment. In a case where the content of the binder in the positive electrode active material satisfies the expression (namely, in a case where the content is in a hatching region represented in FIG. 2), for example, the rate of elongation of the positive electrode active material layer upon rolling of the positive electrode 11 can be close to the rate of elongation of the positive electrode current collector and a binding force between the positive electrode active material layer and the positive electrode current collector can be sufficiently ensured, as compared with a case where the content of the binder in the positive electrode active material is higher than the content derived from the expression 0.006x²+0.0262x+a (x is 1 to 8 and a is 2.2) (namely, a case where the content is above the hatching region represented in FIG. 2) or as compared with a case where the content is lower than the content derived from the expression 0.006x²+0.0262x+a (x is 1 to 8 and a is 0.3) (namely, a case where the content is under the hatching region represented in FIG. 2). Accordingly, peeling of the positive electrode active material layer is suppressed, and then deterioration in charge and discharge cycle characteristics and the temperature rise of a battery upon internal short are suppressed.

The binder preferably has, for example, a molecular weight in the range of 1000000 to 1200000. In a case where the molecular weight of the binder is in the range, for example, the rate of elongation of the positive electrode active material layer upon rolling of the positive electrode 11 is close to the rate of elongation of the positive electrode current collector and a binding force between the positive electrode active material layer and the positive electrode current collector is enhanced, as compared with a case where the molecular weight is out of the range. The molecular weight here refers to the weight average molecular weight measured by a GPC method (gel permeation chromatography).

Examples of the conductive agent include carbon materials such as carbon black, acetylene black, Ketjenblack, and graphite. These may be used singly or may be used in combinations of two or more thereof. The content of the conductive agent in the positive electrode active material is preferably, for example, 0.4 mass % to 5 mass %, more preferably 0.5% to 1.5%.

The stress in tension until the rate of elongation of the positive electrode 11 reaches 1.5% is preferably, for example, in the range of 0.5 N/mm to 5 N/mm from the viewpoint that rupture of the positive electrode current collector and peeling of the positive electrode active material layer are suppressed upon winding of the electrodes. The stress is measured by a universal tester.

[Negative Electrode]

The negative electrode 12 comprises, for example, a negative electrode current collector made of metal foil or the like, and a negative electrode active material layer formed on the current collector. The negative electrode current collector here used can be, for example, foil of a metal, such as copper, which is stable in the electric potential range of the negative electrode, or a film in which such a metal is disposed on an outer layer. The negative electrode active material layer includes a negative electrode active material. The negative electrode active material layer suitably includes a binder, in addition to the negative electrode active material.

The negative electrode active material is not particularly limited as long as such a material can reversibly intercalate and deintercalate lithium ions, and examples include carbon materials such as artificial graphite, natural graphite, amorphous coated graphite, and non-crystalline carbon (low crystalline carbon, amorphous carbon, for example, furnace black, Ketjenblack, channel black, thermal black, acetylene black, carbon nanotube, graphene), non-carbon materials such as SiO, and any mixture of such carbon material and non-carbon material. In the case of a mixture of a carbon material and SiO, the amount of SiO is preferably, for example, in the range of 4 to 70% based on the total amount of the mixture. SiO may contain Li in advance, and the proportion of Si in a compound of Li—Si—O is preferably 10 to 80%. A particle surface of SiO is preferably covered with non-crystalline carbon (low crystalline carbon, amorphous carbon, or the like).

The binder here used can be any binder for use in the positive electrode 11. Examples of others include CMC or salts thereof, styrene-butadiene rubber (SBR), poly(acrylic acid) (PAA) or salts thereof, and poly(vinyl alcohol) (PVA).

[Separator]

For example, an ion-permeable and insulating porous sheet or the like is used as the separator 13. Specific examples of the porous sheet include a microporous thin film, woven fabric, and nonwoven fabric. Suitable examples of the material for the separator include olefin resins such as polyethylene (PE) and polypropylene (PP), and cellulose. The separator 13 may be, for example, a laminate of PP layer/PE layer/PP layer. The separator 13 preferably has a thickness, for example, in the range of 5 to 30 μm. In the case of PP layer/PE layer/PP layer, the PP layer preferably has a thickness in the range of 2 to 10 μm and the PE layer preferably has a thickness in the range of 2 to 10 μm.

A heat-resistant layer is preferably disposed on at least one of the separator 13 (one side or both sides), the positive electrode 11 (one side or both sides), and the negative electrode 12 (one side or both sides). The heat-resistant layer includes a filler and a binder. Examples of the filler include boehmite (alpha alumina), titania (rutile-type or anatase-type, the heat-resistant layer is disposed so as not to be in contact with the negative electrode in the case of anatase-type), zirconia, magnesia, aluminum hydroxide, magnesium hydroxide, and zinc hydroxide. Examples of the binder include acrylic resins, aramid, SBR, and PTFE. The binder content based on the total amount of the heat-resistant layer is preferably in the range of 2 to 30 mass %. The heat-resistant layer preferably has a thickness, for example, in the range of 2 to 12 μm.

[Non-Aqueous Electrolyte]

The non-aqueous electrolyte includes a non-aqueous solvent and an electrolyte salt dissolved in the non-aqueous solvent. The non-aqueous electrolyte is not limited to a liquid electrolyte (non-aqueous electrolyte solution), and may be a solid electrolyte using a gel polymer or the like. Examples of the non-aqueous solvent that can be used include esters, ethers, nitriles such as acetonitrile, amides such as dimethylformamide, and any mixed solvent of two or more thereof. The non-aqueous solvent may contain a halogen-substituted product formed by replacing at least one hydrogen atom of any of the above solvents with a halogen atom such as fluorine.

Examples of the esters include cyclic carbonate esters such as ethylene carbonate (EC), propylene carbonate (PC), and butylene carbonate, chain carbonate esters such as dimethyl carbonate (DMC), ethyl methyl carbonate (EMC), dimethyl carbonate (DMC), methyl propyl carbonate, ethyl propyl carbonate, and methyl isopropyl carbonate, cyclic carboxylate esters such as γ-butyrolactone (GBL) and γ-valerolactone (GVL), and chain carboxylate esters such as methyl acetate, ethyl acetate, propyl acetate, methyl propionate (MP), ethyl propionate, and γ-butyrolactone.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Preferable examples of the halogen-substituted product for use include a fluorinated cyclic carbonate ester such as fluoroethylene carbonate (FEC), a fluorinated chain carbonate ester, and a fluorinated chain carboxylate ester such as methyl fluoropropionate (FMP).

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (where 1<x<6, and n is 1 or 2), LiB₁₀Cl₁₀, LiCl, LiBr, LiI, chloroborane lithium, lithium lower aliphatic carboxylate, borate salts such as Li₂B₄O₇ and Li(B(C₂O₄)F₂), and imide salts such as LiN(SO₂CF₃)₂ and LiN(C₁F₂ₗ₊₁SO₂)(CₘF₂ₘ₊₁SO₂) (where l and m are integers of 0 or more). These lithium salts may be used singly or a plurality thereof may be mixed and used. Among these, LiPF₆ is preferably used in view of ionic conductivity, electrochemical stability, and other properties. The concentration of the lithium salt is preferably 0.8 to 1.8 mol per liter of the non-aqueous solvent.

### EXAMPLES

Hereinafter, the present disclosure will be further described with reference to Examples, but the present disclosure is not intended to be limited to such Examples.

### Example 1

[Production of Positive Electrode]

LiNi_{0.80}Co_{0.15}Al_{0.05}O₂ (having an average particle size (D50) of 9.5 μm and a specific surface area of 2.0 m²/g) was used as a positive electrode active material. PVDF having a molecular weight of 1000000 to 1200000 was used as a binder. A positive electrode current collector foil containing Ti as a main component, having thickness of 1 μm, was used as a positive electrode current collector. The positive electrode current collector foil included 0.2% of Fe, 0.02% of Si, 0.02% of N, 0.02% of C, 0.14% of 0, and 0.001% of H, other than Ti.

Mixed were 98.668 mass % of the positive electrode active material, 0.332 mass % of the binder, and 1 mass % of acetylene black as a conductive agent, and an appropriate amount of NMP was further added thereto to prepare a positive electrode mixture slurry. Next, both sides of the positive electrode current collector were coated with the positive electrode mixture slurry, and the resulting coatings were dried. The coatings were cut out to predetermined electrode sizes, and rolled with roll pressing, to thereby produce a positive electrode in which a positive electrode active material layer was formed on each of both sides of the positive electrode current collector. The positive electrode active material layer had a thickness of 174 μm in terms of both sides thereof, and the positive electrode active material layer had a density of 3.5 g/cm³ in terms of both sides thereof. The stress in tension until the rate of elongation of the positive electrode reached 1.5% was 0.5 N/mm.

[Production of Negative Electrode]

Mixed were 98 mass % of a graphite powder as a negative electrode active material, 1 mass % of CMC (sodium carboxymethyl cellulose), and 1 mass % of SBR (styrene-butadiene rubber), and furthermore an appropriate amount of water was added to thereby prepare a negative electrode mixture slurry. Next, both sides of a negative electrode current collector made of copper foil were coated with the negative electrode mixture slurry, and the resulting coatings were dried. The coatings were cut out to predetermined electrode sizes, and rolled with roll pressing, to thereby produce a negative electrode in which a negative electrode active material layer was formed on each of both sides of the negative electrode current collector.

[Preparation of Non-Aqueous Electrolyte]

A mixed solvent was obtained by mixing ethylene carbonate (EC), ethyl methyl carbonate (EMC), and dimethyl carbonate (DMC) in a volume ratio of 3:3:4, lithium hexafluorophosphate (LiPF₆) was dissolved therein at a concentration of 1.1 mol/L, and Li[B(C₂O₄)₂] and LiPO₂F₂ were added thereto. The resultant was used as a non-aqueous electrolyte.

[Production of Non-Aqueous Electrolyte Secondary Battery]

An aluminum lead and a nickel lead were attached to the positive electrode and the negative electrode, respectively, and the positive electrode and the negative electrode were wound with a polyethylene separator having a thickness of 14 μm being interposed therebetween, to thereby produce a wound-type electrode assembly. The electrode assembly was housed in a cylindrical battery case body, a non-aqueous electrolyte was injected thereto, and thereafter the battery case body was sealed by a gasket and a sealing assembly. The resultant was adopted as a non-aqueous electrolyte secondary battery.

[Measurement of Rate of Increase in Resistance in Charge and Discharge Cycle]

The non-aqueous electrolyte secondary battery of Example 1 was charged at 2.5 C for 240 seconds and discharged at 30 C for 20 seconds. The rest time between charge and discharge was 120 seconds. The charge and discharge cycle was performed for 1000 cycles. The resistance of the battery after 1 cycle and the resistance of the battery after 1000 cycles were measured, and the resistance of the battery after 1000 cycles was calculated as a relative value to the resistance of the battery after 1 cycle, defined as a reference (100), and was defined as the rate of increase in resistance in the charge and discharge cycle. The results of the rate of increase in resistance in the charge and discharge cycle are shown in Table 3. It was here indicated that, as the rate of increase in resistance in the charge and discharge cycle was lower, deterioration in charge and discharge cycle characteristics was more suppressed.

[Measurement of Maximum Temperature of Battery in Nailing Test]

The non-aqueous electrolyte secondary battery of Example 1 was charged and then warmed to 60° C. The tip of a round nail having a thickness of 3 mmφ was brought into contact with the center portion on the side surface of the battery, the round nail was stuck in a diameter direction of the battery at a speed of 10 mm/sec, and the sticking of the round nail was stopped when the round nail completely penetrated through the battery. The temperature of the battery was measured at a position of 10 mm from the center portion on the side surface of the battery, to which the round nail was stuck, and the maximum temperature was determined. The results are shown in Table 3. It was here indicated that, as the maximum temperature was lower, the temperature rise of the battery upon internal short was more suppressed.

### Examples 2 to 9 and Comparative Examples 1 to 5

Each non-aqueous electrolyte secondary battery was produced in the same manner as in Example 1 except that each positive electrode was produced by changing the thickness of the positive electrode current collector, the content of the binder in the positive electrode active material layer, the positive electrode active material, the thickness and the density of the positive electrode active material layer, and the like, as shown in Table 1 to 3. The rate of increase in resistance in the charge and discharge cycle and the maximum temperature of such each battery in the nailing test were measured in the same manner as in Example 1. The results are shown in Table 1 to 3.

TABLE 1

| | | | | | | | Average | Specific | | | Density of |
|---|---|---|---|---|---|---|---|---|---|---|---|
| | | Thick- | | | | | particle | surface | Stress at | Thick- | positive |
| | Type of | ness of | | | | | size of | area of | rate of | ness of | electrode |
| | positive | positive | | | | | positive | positive | elongation | positive | active |
| | electrode | Electrode | | | | Positive | electrode | electrode | of 1.5% | electrode | material |
| | current | current | Binder | | Molecular | electrode | active | active | of positive | active | layer/ |
| | collector | collector | content/ | Type of | weight of | active | material | material/ | electrode/ | material | g · |
| | foil | foil/μm | % | binder | binder | material | (D50)/μm | m² · g⁻¹ | N · mm⁻¹ | layer/μm | cm⁻³ |
| Example 1 | Ti | 1 | 0.332 | PVDF | 1000000 to | NixCoyAlz | 9.5 | 2.00 | 0.5 | 174 | 3.5 |
| | | | | | 1200000 | x:y:z = 80:15:5 | | | | | |
| Example 2 | Ti | 1 | 2.232 | PVDF | 1000000 to | NixCoyAlz | 9.5 | 2.00 | 0.5 | 174 | 3.5 |
| | | | | | 1200000 | x:y:z = 82:15:3 | | | | | |
| Example 3 | Ti | 3 | 0.833 | PVDF | 1000000 to | NixCoyAlz | 9.5 | 2.00 | 1.9 | 174 | 3.5 |
| | | | | | 1200000 | x:y:z = 80:15:5 | | | | | |
| Example 4 | Ti | 3 | 1.933 | PVDF | 1000000 to | NixCoyMnz | 9.5 | 2.00 | 19 | 174 | 3.5 |
| | | | | | 1200000 | x:y:z = 85:3:10 | | | | | |
| Example 5 | Ti | 4 | 0.900 | PVDF | 1000000 to | NixCoyAlz | 9.5 | 2.00 | 23 | 174 | 3.5 |
| | | | | | 1200000 | x:y:z = 80:15:5 | | | | | |
| Example 6 | Ti | 6 | 1.173 | PVDF | 1000000 to | NixCoyAlz | 9.5 | 2.00 | 3.1 | 174 | 3.5 |
| | | | | | 1200000 | x:y:z = 80:15:5 | | | | | |
| Example 7 | Ti | 6 | 2.273 | PVDF | 1000000 to | NixCoyMnz | 9.5 | 2.00 | 3.1 | 174 | 33 |
| | | | | | 1200000 | x:y:z = 85:5:10 | | | | | |
| Example 8 | Ti | 8 | 0.894 | PVDF | 1000000 to | NixCoyAlz | 9.5 | 2.00 | 5 | 174 | 3.5 |
| | | | | | 1200000 | x:y:z = 80:15:3 | | | | | |
| Example 9 | Ti | 8 | 2.794 | PVDF | 1000000 to | NixCoyAlz | 9.5 | 2.00 | 5 | 174 | 3.5 |
| | | | | | 1200000 | x:y:z = 94:3:3 | | | | | |

TABLE 2

| | | | | | | | Average | Specific | | | Density of |
|---|---|---|---|---|---|---|---|---|---|---|---|
| | | Thick- | | | | | particle | surface | Stress at | Thick- | positive |
| | Type of | ness of | | | | | size of | area of | rate of | ness of | electrode |
| | positive | positive | | | | | positive | positive | elongation | positive | active |
| | electrode | Electrode | | | | Positive | electrode | electrode | of 1.5% | electrode | material |
| | current | current | Binder | | Molecular | electrode | active | active | of positive | active | layer/ |
| | collector | collector | content/ | Type of | weight of | active | material | material/ | electrode/ | material | g · |
| | foil | foil/μm | % | binder | binder | material | (D50)/μm | m² · g⁻¹ | N · mm⁻¹ | layer/μm | cm⁻³ |
| Comparative | Ti | 0.7 | 0.121 | PVDF | 1000000 to | NixCoyAlz | 9.5 | 2.00 | 03 | 174 | 3.5 |
| Example 1 | | | | | 1200000 | x:y:z = 80:15:5 | | | | | |
| Comparative | Ti | 0.7 | 3.021 | PVDF | 1000000 to | NixCoyAlz | 9.5 | 2.00 | 03 | 174 | 3.5 |
| Example 2 | | | | | 1200000 | x:y:z = 80:15:5 | | | | | |
| Comparative | Ti | 10 | 0.862 | PVDF | 1000000 to | NixCoyAlz | 9.5 | 2.00 | 56 | 174 | 3.5 |
| Example 3 | | | | | 1200000 | x:y:z = 80:15:5 | | | | | |
| Comparative | Ti | 10 | 3.862 | PVDF | 1000000 to | NixCoyAlz | 9.5 | 2.00 | 56 | 174 | 3.5 |
| Example 4 | | | | | 1200000 | x:y:z = 80:15:5 | | | | | |
| Comparative | Al | 12 | 0.900 | PVDF | 1000000 to | NixCoyAlz | 9.5 | 2.00 | 2.95 | 174 | 3.5 |
| Example 5 | | | | | 1200000 | x:y:z = 80:15:5 | | | | | |

TABLE 3

| | | | | | | | Rate of increase in | |
|---|---|---|---|---|---|---|---|---|
| | Content of element other | | | | | | resistance (calculated | Maximum |
| | than Ti in positive electrode | | | | | | with initial resistance | temperature |
| | current collector foil | | | | | | of 100) by charge | of battery/ |
| | Fe | Si | N | C | O | H | and discharge cycle | ° C. |
| Example 1 | 0.2 | 0.02 | 0.02 | 0.02 | 0.14 | 0.001 | 132 | 196 |
| Example 2 | 0.2 | 0.02 | 0.02 | 0.02 | 0.14 | 0.001 | 134 | 196 |
| Example 3 | 0.2 | 0.02 | 0.02 | 0.02 | 0.14 | 0.001 | 136 | 189 |
| Example 4 | 0.2 | 0.02 | 0.02 | 0.02 | 0.14 | 0.001 | 138 | 187 |
| Example 5 | 0.2 | 0.02 | 0.02 | 0.02 | 0.14 | 0.001 | 139 | 181 |
| Example 6 | 0.2 | 0.02 | 0.02 | 0.02 | 0.14 | 0.001 | 139 | 179 |
| Example 7 | 0.2 | 0.02 | 0.02 | 0.02 | 0.14 | 0.001 | 140 | 178 |
| Example 8 | 0.2 | 0.02 | 0.02 | 0.02 | 0.14 | 0.001 | 148 | 176 |
| Example 9 | 0.2 | 0.02 | 0.02 | 0.02 | 0.14 | 0.001 | 149 | 174 |
| Comparative | 0.2 | 0.02 | 0.02 | 0.02 | 0.14 | 0.001 | 133 | 260 |
| Example 1 | | | | | | | | |
| Comparative | 0.2 | 0.02 | 0.02 | 0.02 | 0.14 | 0.001 | 132 | 261 |
| Example 2 | | | | | | | | |
| Comparative | 0.2 | 0.02 | 0.02 | 0.02 | 0.14 | 0.001 | 300 | 182 |
| Example 3 | | | | | | | | |
| Comparative | 0.2 | 0.02 | 0.02 | 0.02 | 0.14 | 0.001 | 350 | 185 |
| Example 4 | | | | | | | | |
| Comparative | — | — | — | — | — | — | 486 | 390 |
| Examnle 5 | | | | | | | | |

### Examples 10 to 21

Each non-aqueous electrolyte secondary battery was produced in the same manner as in Example 1 except that each positive electrode was produced by changing the thickness of the positive electrode current collector, the content of the binder in the positive electrode active material layer, the positive electrode active material, the thickness and the density of the positive electrode active material layer, and the like, as shown in Table 4 to 6. The rate of increase in resistance in the charge and discharge cycle and the maximum temperature of such each battery in the nailing test were measured in the same manner as in Example 1. The results are shown in Table 4 to 6.

TABLE 4

| | | | | | | Average | Specific | | | Density of |
|---|---|---|---|---|---|---|---|---|---|---|
| | Thick- | | | | | particle | surface | Stress at | Thick- | positive |
| | ness of | | | | | size of | area of | rate of | ness of | electrode |
| | positive | | | | | positive | positive | elongation | positive | active |
| | Electrode | | | | Positive | electrode | electrode | of 1.5% | electrode | material |
| | current | Binder | | Molecular | electrode | active | active | of positive | active | layer/ |
| | collector | content/ | Type of | weight of | active | material | material/ | electrode/ | material | g · |
| | foil/μm | % | binder | binder | material | (D50)/μm | m² · g⁻¹ | N · mm⁻¹ | layer/μm | cm⁻³ |
| Example 10 | 4.5 | 1.000 | PVDF | 1000000 to | NixCoyMnz | 2 | 2 | 220 | 166 | 3.6 |
| | | | | 1200000 | x:y:z = 70-22:8 | | | | | |
| Example 11 | 4.5 | 1.000 | PVDF | 1000000 to | NixCoyMnz | 5 | 1.8 | 220 | 166 | 3.6 |
| | | | | 1200000 | x:y:z = 80:15:5 | | | | | |
| Example 12 | 4.5 | 1.000 | PVDF | 1000000 to | NixCoyMnz | 9 | 1.3 | 220 | 166 | 3.6 |
| | | | | 1200000 | x:y:z = 82:15:3 | | | | | |
| Example 13 | 4.5 | 1.000 | PVDF | 1000000 to | NixCoyMnz | 11 | 1.00 | 220 | 166 | 3.6 |
| | | | | 1200000 | x:y:z = 85:5:10 | | | | | |
| Example 14 | 4.5 | 1.000 | PVDF | 1000000 to | NixCoyMnz | 15 | 0.5 | 220 | 166 | 3.6 |
| | | | | 1200000 | x:y:z = 92:5:3 | | | | | |
| Example 15 | 4.5 | 1.000 | PVDF | 1000000 to | NixCoyMnz | 20 | 0.15 | 220 | 166 | 3.6 |
| | | | | 1200000 | x:y:z = 98:1:1 | | | | | |
| Example 16 | 4.5 | 1.000 | PVDF | 1000000 to | NixCoyAlz | 3 | 2 | 220 | 166 | 3.6 |
| | | | | 1200000 | x:y:z = 70:22:8 | | | | | |
| Example 17 | 4.5 | 1.000 | PVDF | 1000000 to | NixCoyAlz | 6 | 1 | 220 | 166 | 3.6 |
| | | | | 1200000 | x:y:z = 82:15:3 | | | | | |
| Example 18 | 4.5 | 1.000 | PVDF | 1000000 to | NixCoyAlz | 9 | 0.50 | 220 | 166 | 3.6 |
| | | | | 1200000 | x:y:z = 88:9:3 | | | | | |

TABLE 5

| | | | | | | Average | Specific | | | Density of |
|---|---|---|---|---|---|---|---|---|---|---|
| | Thick- | | | | | particle | surface | Stress at | Thick- | positive |
| | ness of | | | | | size of | area of | rate of | ness of | electrode |
| | positive | | | | | positive | positive | elongation | positive | active |
| | Electrode | | | | Positive | electrode | electrode | of 1.5% | electrode | material |
| | current | Binder | | Molecular | electrode | active | active | of positive | active | layer/ |
| | collector | content/ | Type of | weight of | active | material | material/ | electrode/ | material | g · |
| | foil/μm | % | binder | binder | material | (D50)/μm | m² · g⁻¹ | N · mm⁻¹ | layer/μm | cm⁻³ |
| Example 19 | 4.5 | 1.000 | PVDF | 1000000 to | NixCoyAlz | 11 | 0.3 | 220 | 166 | 3.6 |
| | | | | 1200000 | x:y:z = 92:5:3 | | | | | |
| Example 20 | 4.5 | 1.000 | PVDF | 1000000 to | NixCoyAlz | 16 | 0.2 | 220 | 166 | 3.6 |
| | | | | 1200000 | x:y:z = 94:3:3 | | | | | |
| Example 21 | 4.5 | 1.000 | PVDF | 1000000 to | NixCoyMnz | 19 | 0.15 | 220 | 166 | 3.6 |
| | | | | 1200000 | x:y:z = 98:1:1 | | | | | |

TABLE 6

| | | | | | | | Rate of increase in | |
|---|---|---|---|---|---|---|---|---|
| | Content of element other | | | | | | resistance (calculated | Maximum |
| | than Ti in positive electrode | | | | | | with initial resistance | temperature |
| | current collector foil | | | | | | of 100) by charge | of battery/ |
| | Fe | Si | N | C | O | H | and discharge cycle | ° C. |
| Example 10 | 0.05 | 0.015 | 0.002 | 0.005 | 0.05 | 0.005 | 145 | 190 |
| Example 11 | 0.05 | 0.015 | 0.002 | 0.005 | 0.05 | 0.005 | 144 | 188 |
| Example 12 | 0.05 | 0.015 | 0.002 | 0.005 | 0.05 | 0.005 | 143 | 186 |
| Example 13 | 0.05 | 0.015 | 0.002 | 0.005 | 0.05 | 0.005 | 142 | 184 |
| Example 14 | 0.05 | 0.015 | 0.002 | 0.005 | 0.05 | 0.005 | 140 | 182 |
| Example 15 | 0.05 | 0.015 | 0.002 | 0.005 | 0.05 | 0.005 | 139 | 181 |
| Example 16 | 0.05 | 0.015 | 0.002 | 0.005 | 0.05 | 0.005 | 144 | 189 |
| Example 17 | 0.05 | 0.015 | 0.002 | 0.005 | 0.05 | 0.005 | 143 | 187 |
| Example 18 | 0.05 | 0.015 | 0.002 | 0.005 | 0.05 | 0.005 | 142 | 185 |
| Example 19 | 0.05 | 0.015 | 0.002 | 0.005 | 0.05 | 0.005 | 141 | 183 |
| Example 20 | 0.05 | 0.015 | 0.002 | 0.005 | 0.05 | 0.005 | 140 | 181 |
| Example 21 | 0.05 | 0.015 | 0.002 | 0.005 | 0.05 | 0.005 | 138 | 180 |

### Examples 22 to 26

Each non-aqueous electrolyte secondary battery was produced in the same manner as in Example 1 except that each positive electrode was produced by changing the thickness of the positive electrode current collector, the content of the binder in the positive electrode active material layer, the positive electrode active material, the thickness and the density of the positive electrode active material layer, and the like, as shown in Table 7 to 8. The rate of increase in resistance in the charge and discharge cycle and the maximum temperature of such each battery in the nailing test were measured in the same manner as in Example 1. The results are shown in Table 7 to 8.

TABLE 7

| | | | | | | Average | Specific | | | Density of |
|---|---|---|---|---|---|---|---|---|---|---|
| | Thick- | | | | | particle | surface | Stress at | Thick- | positive |
| | ness of | | | | | size of | area of | rate of | ness of | electrode |
| | positive | | | | | positive | positive | elongation | positive | active |
| | Electiode | | | | Positive | electrode | electrode | of 1.5% | electrode | material |
| | current | Binder | | Molecular | electrode | active | active | of positive | active | layer/ |
| | collector | content/ | Type of | weight of | active | material | material/ | electrode/ | material | g · |
| | foil/μm | % | binder | binder | material | (D50)/μm | m² · g⁻¹ | N · mm⁻¹ | layer/μm | cm⁻³ |
| Example 22 | 4.8 | 1.000 | PVDF | 1000000 to | NixCoyMnz | 10 | 0.5 | 250 | 95 | 3.65 |
| | | | | 1200000 | x:y:z = 85:5:10 | | | | | |
| Example 23 | 4.8 | 1.000 | PVDF | 1000000 to | NixCoyMnz | 10 | 0.5 | 250 | 100 | 3.65 |
| | | | | 1200000 | x:y:z = 85:5:10 | | | | | |
| Example 24 | 4.8 | 1.000 | PVDF | 1000000 to | NixCoyMnz | 10 | 0.5 | 250 | 170 | 3.65 |
| | | | | 1200000 | x:y:z = 85:5:10 | | | | | |
| Example 25 | 4.8 | 1.000 | PVDF | 1000000 to | NixCoyMnz | 10 | 0.5 | 250 | 250 | 3.65 |
| | | | | 1200000 | x:y.z = 85:5:10 | | | | | |
| Example 26 | 4.8 | 1.000 | PVDF | 1000000 to | NixCoyMnz | 10 | 0.5 | 250 | 300 | 3.65 |
| | | | | 1200000 | x:y:z = 85:5:10 | | | | | |

TABLE 8

| | | | | | | | Rate of increase in | |
|---|---|---|---|---|---|---|---|---|
| | Content of element other | | | | | | resistance (calculated | Maximum |
| | than Ti in positive electrode | | | | | | with initial resistance | temperature |
| | current collector foil | | | | | | of 100) by charge | of battery/ |
| | Fe | Si | N | C | O | H | and discharge cycle | ° C. |
| Example 22 | 0.05 | 0.015 | 0.002 | 0.005 | 0.05 | 0.005 | 134 | 209 |
| Example 23 | 0.05 | 0.015 | 0.002 | 0.005 | 0.05 | 0.005 | 138 | 189 |
| Example 24 | 0.05 | 0.015 | 0.002 | 0.005 | 0.05 | 0.005 | 146 | 194 |
| Example 25 | 0.05 | 0.015 | 0.002 | 0.005 | 0.05 | 0.005 | 150 | 198 |
| Example 26 | 0.05 | 0.015 | 0.002 | 0.005 | 0.05 | 0.005 | 152 | 208 |

### Comparative Example 6 and Examples 27 to 29

Each non-aqueous electrolyte secondary battery was produced in the same manner as in Example 1 except that each positive electrode was produced by changing the thickness of the positive electrode current collector, the content of the binder in the positive electrode active material layer, the positive electrode active material, the thickness and the density of the positive electrode active material layer, and the like, as shown in Table 9 to 10. The rate of increase in resistance in the charge and discharge cycle and the maximum temperature of such each battery in the nailing test were measured in the same manner as in Example 1. The results are shown in Table 9 to 10.

TABLE 9

| | | | | | | Average | Specific | | | Density of |
|---|---|---|---|---|---|---|---|---|---|---|
| | Thick- | | | | | particle | surface | Stress at | Thick- | positive |
| | ness of | | | | | site of | area of | rate of | ness of | electrode |
| | positive | | | | | positive | positive | elongation | positive | active |
| | Electrode | | | | Positive | electrode | electrode | of 1.5% | electrode | material |
| | current | Binder | | Molecular | electrode | active | active | of positive | active | layer/ |
| | collector | content/ | Type of | weight of | active | material | material/ | electrode/ | material | g · |
| | foil/μm | % | binder | binder | material | (D50)/μm | m² · g⁻¹ | N · mm⁻¹ | layer/μm | cm⁻³ |
| Comparative | 4.9 | 1.000 | PVDF | 1000000 to | NixCoyMnz | 11 | 0.45 | 260 | 180 | 2.9 |
| Example 6 | | | | 1200000 | x:y:z = 86:4:10 | | | | | |
| Example 27 | 4.9 | 1.000 | PVDF | 1000000 to | NixCoyMnz | 11 | 0.45 | 260 | 180 | 3 |
| | | | | 1200000 | x:y:z = 86:4:10 | | | | | |
| Example 28 | 4.9 | 1.000 | PVDF | 1000000 to | NixCoyMnz | 11 | 0.45 | 260 | 180 | 3.5 |
| | | | | 1200000 | x:y:z = 86:4:10 | | | | | |
| Example 29 | 4.9 | 1.000 | PVDF | 1000000 to | NixCoyMnz | 11 | 0.45 | 260 | 180 | 3.7 |
| | | | | 1200000 | x:y:z = 86:4:10 | | | | | |

TABLE 10

| | | | | | | | Rate of increase in | |
|---|---|---|---|---|---|---|---|---|
| | Content of element other | | | | | | resistance (calculated | Maximum |
| | than Ti in positive electrode | | | | | | with initial resistance | temperature |
| | current collector foil | | | | | | of 100) by charge | of battery/ |
| | Fe | Si | N | C | O | H | and discharge cycle | ° C. |
| Comparative | 0.04 | 0.015 | 0.002 | 0.005 | 0.05 | 0.005 | 204 | 192 |
| Example 6 | | | | | | | | |
| Example 27 | 0.04 | 0.015 | 0.002 | 0.005 | 0.05 | 0.005 | 143 | 194 |
| Example 28 | 0.04 | 0.015 | 0.002 | 0.005 | 0.05 | 0.005 | 139 | 196 |
| Example 29 | 0.04 | 0.015 | 0.002 | 0.005 | 0.05 | 0.005 | 138 | 199 |

### Examples 30 to 33

Each non-aqueous electrolyte secondary battery was produced in the same manner as in Example 1 except that each positive electrode was produced by changing the thickness of the positive electrode current collector, the content of the binder in the positive electrode active material layer, the positive electrode active material, the thickness and the density of the positive electrode active material layer, and the like, as shown in Table 11 to 12. The rate of increase in resistance in the charge and discharge cycle and the maximum temperature of such each battery in the nailing test were measured in the same manner as in Example 1. The results are shown in Table 11 to 12.

TABLE 11

| | | | | | | Average | Specific | | | Density of |
|---|---|---|---|---|---|---|---|---|---|---|
| | Thick- | | | | | particle | surface | Stress at | Thick- | positive |
| | ness of | | | | | size of | area of | rate of | ness of | electrode |
| | positive | | | | | positive | positive | elongation | positive | active |
| | Electrode | | | | Positive | electrode | electrode | of 1.5% | electrode | material |
| | current | Binder | | Molecular | electrode | active | active | of positive | active | layer/ |
| | collector | content/ | Type of | weight of | active | material | material/ | electrode/ | material | g · |
| | foil/μm | % | binder | binder | material | (D50)/μm | m² · g⁻¹ | N · mm⁻¹ | layer/μm | cm⁻³ |
| Example 30 | 5 | 1.000 | PVDF | 1000000 to | NixCoyAlz | 12 | 0.41 | 2.80 | 179 | 3.7 |
| | | | | 1200000 | x:y:z = 88:8:4 | | | | | |
| Example 31 | 5 | 1.000 | PVDF | 1000000 to | NixCoyAlz | 12 | 0.41 | 2.80 | 179 | 3.7 |
| | | | | 1200000 | x:y:z = 88:8:4 | | | | | |
| Example 32 | 5 | 1.000 | PVDF | 1000000 to | NixCoyAlz | 12 | 0.41 | 2.80 | 179 | 3.7 |
| | | | | 1200000 | x:y:z = 88:8:4 | | | | | |
| Example 33 | 5 | 1.000 | PVDF | 1000000 to | NixCoyAlz | 12 | 0.41 | 2.80 | 179 | 3.7 |
| | | | | 1200000 | x:y:z = 88:8:4 | | | | | |

TABLE 12

| | | | | | | | Rate of increase in | |
|---|---|---|---|---|---|---|---|---|
| | Content of element other | | | | | | resistance (calculated | Maximum |
| | than Ti in positive electrode | | | | | | with initial resistance | temperature |
| | current collector foil | | | | | | of 100) by charge | of battery/ |
| | Fe | Si | N | C | O | H | and discharge cycle | ° C. |
| Example 30 | 0.2 | 0.02 | 0.02 | 0.02 | 0.14 | 0.001 | 174 | 194 |
| Example 31 | 0.05 | 0.015 | 0.002 | 0.005 | 0.05 | 0.005 | 173 | 194 |
| Example 32 | 0.01 | 0.011 | 0.001 | 0.001 | 0.04 | 0.003 | 170 | 195 |
| Example 33 | 0.21 | 0.025 | 0.03 | 0.04 | 0.15 | 0.013 | 178 | 199 |

In each of Examples 1 to 33, the positive electrode active material layer included a positive electrode active material and a binder and had a density of 3 g/cc or more, the positive electrode active material had an average particle size in the range of 2 μm to 20 μm, the positive electrode current collector containing Ti as a main component had a thickness in the range of 1 μm to 8 μm, and the content of the binder in the positive electrode active material layer satisfied the following expression: y=0.006x²+0.0262x+a (y is the binder content (mass %), x is the thickness of the positive electrode current collector, and a was a real number of 0.3 to 2.2). Each of the non-aqueous electrolyte secondary batteries of Examples 1 to 33 was suppressed in both deterioration in charge and discharge cycle characteristics and the temperature rise of the battery upon internal short. On the other hand, all Comparative Examples 1 to 6 did not satisfy any of the above configurations. Each of the non-aqueous electrolyte secondary batteries of Comparative Examples 1 to 6 was not suppressed in deterioration in charge and discharge cycle characteristics or the temperature rise of the battery upon internal short.

### REFERENCE SIGNS LIST

10 non-aqueous electrolyte secondary battery
11 positive electrode
12 negative electrode
13 separator
14 electrode assembly
15 battery case
16 case body
17 sealing assembly
18, 19 insulating plate
20 positive electrode lead
21 negative electrode lead
22 projecting portion
23 filter
24 lower vent member
25 insulating member
26 upper vent member
27 cap
28 gasket

1. A positive electrode for a non-aqueous electrolyte secondary battery, comprising:
a positive electrode current collector containing Ti as a main component; and
a positive electrode active Material layer disposed on the positive electrode current collector, wherein
the positive electrode active material layer includes a positive electrode active material and a binder, and has a density of 3 g/cc or more,
the positive electrode active material has an average particle size in the range of 2 μm to 20 μm,
the positive electrode current collector has a thickness in the range of 1 μm to 8 μm, and
a content of the binder in the positive electrode active material layer satisfies the following expression:
y=0.006x²+0.0262x+a
wherein y is the binder content (mass %), x is the thickness of the positive electrode current collector, and a is a real number of 0.3 to 2.2.

2. The positive electrode for a non-aqueous electrolyte secondary battery according to claim 1, wherein a stress in tension until a rate of elongation of the positive electrode for a non-aqueous electrolyte secondary battery reaches 1.5% is in the range of 0.5 N/mm to 5 N/mm.

3. The positive electrode for a non-aqueous electrolyte secondary battery according to claim 1, wherein the positive electrode active material layer has a thickness in the range of 100 μm to 250 μm.

4. The positive electrode for a non-aqueous electrolyte secondary battery according to claim 1, wherein the positive electrode current collector includes at least one selected from the group consisting of Fe, Si, N, C, O, and H.

5. A non-aqueous electrolyte secondary battery, comprising:
a positive electrode;
a negative electrode; and
a non-aqueous electrolyte, wherein
the positive electrode is the positive electrode for a non-aqueous electrolyte secondary battery according to claim 1.
